(19) United States
(12) Patent Application Publication
(10) Pub. No.: US 2013/0206885 A1
(43) Pub. Date: Aug. 15, 2013

(54) CRUSHING DEVICE

(71) Applicants: Toshiharu Ueda, Ibaraki-shi (JP); Kuniyuki Ueda, Ibaraki-shi (JP)

(72) Inventors: Toshiharu Ueda, Ibaraki-shi (JP); Kuniyuki Ueda, Ibaraki-shi (JP)

(21) Appl. No.: 13/808,775

(22) PCT Filed: Jul. 14, 2011
(86) PCT No.: PCT/JP2011/066100

§ 371 Date: Feb. 4, 2013

(30) Foreign Application Priority Data
Jul. 20, 2010 (JP) 2010-163063

(51) Int. Cl. B02C 18/06; B02C 18/14; B02C 18/22; B02C 21/02

(52) U.S. Cl. CPC B02C 18/06; B02C 21/026; B02C 18/14; B02C 18/2241
USPC 241/101.72; 241/101.74; 241/242

(57) ABSTRACT

A crushing device comprises a crushing mechanism for crushing an object, the crushing mechanism performing the crushing operation by a stationary blade and a crushing rotor which is rotationally driven by a crushing motor; a conveying mechanism for pressing and conveying the object to the crushing mechanism by a conveying roller rotationally driven by a conveying motor; a pressing mechanism for pressing the conveying mechanism to the object by an arm cylinder; and a hopper for receiving the object. The drive force of the arm cylinder is controlled according to the drive load of the conveying motor, and the rotational speed of the conveying motor is controlled according to the drive load of the crushing motor.

### TECHNICAL FIELD

The present invention relates to a crushing device for crushing arborous material such as bamboo, thinned wood and waste wood into chips.

### BACKGROUND TECHNOLOGY

Conventionally, a crushing device which has a conveyor for conveying loaded arborous object to be crushed downstream in the conveying direction and a conveying roller for pressing and introducing the object to be crushed into the crushing mechanism in cooperation with the conveyor, and which finely crushes the object to be crushed forwarded by the conveyor and roller by the crushing mechanism equipped with stationary blades and crushing blades is publicly known.

The self-propelled crushing device in Patent Document 1 has a crushing mechanism for crushing the object to be crushed and a conveying mechanism for conveying the object to be crushed to the crushing mechanism. The crushing mechanism comprises a crushing rotor rotatably mounted on a main body frame, a plurality of crushing blades fixed onto the periphery of the crushing rotor for crushing the conveyed object to be crushed in cooperation with the stationary blades and a crushing motor for rotating the crushing rotor around a rotary shaft.

The conveying mechanism comprises a feed conveyor for conveying the object to be crushed, a conveying roller (pressure roller) capable of pressing the object to be crushed, a drive motor for rotating the conveying roller, an arm holding the conveying roller on one end and the other end being rotationally mounted, on the main body frame by means of the rotary shaft, and a hydraulic cylinder for swinging the arm.
Patent Document #1: Japanese Laid-Open Patent Publication 2008-284493

### SUMMARY OF THE INVENTION

### Problems to be Solved by the Invention

The crushing device is a self-propelled crushing device made exclusively for crushing and equipped with a feed conveyor for conveying the object to be crushed. Hence, it is a crushing device of large size, inevitably raising production costs, and a skilled operator is required as well.

The crushing device is a self-propelled crushing device capable of moving by a pair of caterpillars on the left and right sides and conveys the object to be crushed by the feed conveyor. Hence it is not suitable for receiving and crushing the object to be crushed in poor working environments such as sloped grounds. For example, the crushing device as a whole cannot move swiftly to facilitate receipt of the object to be crushed and output of the processed object.

Moreover, since the length of the feed conveyor is pre-determined, the length may be insufficient when crushing long objects such as bamboo and thinned wood. The crushing device is made to adjust the gap between the feed conveyor and the conveying roller by means of the hydraulic cylinder coupled to the member for supporting the conveying roller. Hence the stroke of the cylinder has to be adjusted depending on the thickness of the object to be crushed by the operator, imposing extra burden on the operator for adjusting the stroke of the cylinder.

The objective of the present invention is to provide a compact crushing device fabricated with least production costs, a crushing device which can increase the crushing efficiency even in poor working environments such as sloped grounds, a crushing device with a replaceable hopper which can be chosen depending on the length of the object to be crushed, and a crushing device which can reduce the operating burden of the operator and so on.

### Means to Solve the Problems

The present invention relates to a crushing device comprising a main body frame pivotally coupled to an end of an arm of a shovel type excavator, stationary blades fitted on the main body frame and crushing blades for crushing conveyed object to be crushed in cooperation with the stationary blades, wherein the crushing device comprises: a crushing mechanism comprising a crushing rotor rotationally mounted on the main body frame, a plurality of the crushing blades fitted on a periphery of the crushing rotor and a crushing motor for rotating the crushing rotor around a rotary shaft; a conveying mechanism comprising a conveying roller provided on an upstream side of the crushing mechanism for pressing and conveying the object to be crushed to the crushing mechanism and a conveying motor for rotating the conveying roller; a pressing mechanism comprising an arm member holding the conveying mechanism on one end, a swing shaft pivotally supporting the arm member on the main body frame and an arm drive means coupled to the other end of the arm member for adjusting a pressing force of the conveying roller against the object to be crushed; a hopper capable of receiving the loaded object to be crushed and provided on the main body frame detachably or integrally on an upstream side than the conveying mechanism.

Additionally the present invention may be provided with the following various features.

Feature A: Provided are a first drive load detection means for detecting a drive load of the conveying motor and a control means for controlling a drive load of the arm drive means depending on the drive load of the conveying motor.

Feature B: The control means reduces the pressing force of the conveying roller when the drive load of the conveying motor is larger than a first set load.

Feature C: Provided is a second drive load detection means for detecting a drive load of the crushing motor and the control means controls the conveying motor to reduce a conveying speed of the object to be crushed when the drive load of the crushing motor is larger than a second set load.

Feature D: The crushing motor and the conveying motor are both hydraulic motors and wherein provided are a hydraulic pump to supply hydraulic fluid at least to the crushing motor and the conveying motor, a hydraulic power generating engine for driving the hydraulic pump, and a switch for switching the hydraulic power generating engine from an idling state to an operating state wherein an engine rotation speed is higher than that of the idling state; and wherein even when the switch is set to the operating state, the hydraulic power generating engine is switched from the operating state to the idling state in case where the drive load of the crushing motor and the conveying motor is smaller than a third set load.

Feature E: The crushing motor has a first motor for light load detachably mounted on one end of the rotary shaft of the crushing rotor and a second motor for heavy load detachably mounted on the other end of the rotary shaft of the crushing rotor.

### Advantages of the Invention

According to the present invention, the main body frame of the crushing device is coupled to the end of the arm of a shovel type excavator. Hence by changing the position and the posture of the arm, the crushing device can be moved to an arbitrary position or change its posture. Thus, crushing efficiency in poor working environments such as sloped grounds can be increased. Also, travelling means such as a self-propelling means for moving the crushing device can be omitted. Hence the size and the weight of the crushing device can be reduced, and production costs can be reduced.

In case where a removable hopper is provided on the main body frame, it can be replaced with another hopper suitable for the object to be crushed so that efficiency to load the object to be crushed is increased and the object can be supplied without fail to the crushing mechanism by the conveying mechanism.

The pressing mechanism is equipped with the arm member supporting the conveying mechanism on one end, the swing shaft pivotally supporting the arm member on the main body frame and the arm drive means coupled to the other end of the arm member, for adjusting the pressing force of the conveying roller against the object to be crushed. Hence the object to be crushed can be smoothly conveyed to the crushing mechanism while adjusting the pressing force of the conveying roller depending on the type of the object to be crushed.

According to Feature A, the control means controls the driving force of the arm drive means depending on the drive load of the conveying motor. Hence proper positional relationship between the conveying roller and the object to be crushed can be maintained depending on the type of the object to be crushed, and the object can be conveyed without fail to the crushing mechanism and crushed. Moreover, sufficient conveying force for the object to be crushed can be ensured so as to prevent decrease in the conveying speed and the crushing efficiency.

According to Feature B, the pressing force of the conveying roller is reduced when the conveying load of the conveying motor is larger than the first set load. Hence even when the object to be crushed is large, it is conveyed without fail to the crushing mechanism by the conveying roller and crushed.

According to Feature C, the conveying speed of the object to be crushed is reduced when the drive load of the crushing motor is larger than the second set load. Hence appropriate volume of the object to be crushed is supplied to the crushing mechanism, thus avoiding excessive supply of the object.

According to Feature D, an operator will no longer be necessary in the cabin of the excavator to operate the crushing device. Moreover, when the amount of the object to be crushed is small, the hydraulic power generating engine is automatically switched to an idle state, thus reducing energy consumption.

According to Feature E, depending on the supplied volume and the property, such as hardness, of the object to be crushed, either the first motor for light load or the second motor for heavy load can be chosen for driving the crushing motor, thus increasing the crushing efficiency.

### BRIEF DESCRIPTION OF THE DRAWINGS

FIG. 1 is an external side view of the excavator and a crushing device according to Embodiment 1 of the present invention.

FIG. 2 is a side view of the crushing device.

FIG. 3 is a plan view of the crushing device.

FIG. 4 is a plan view of the crushing device without a hopper

FIG. 5 is a sectional view taken along the line V-V in FIG. 4.

FIG. 6 is a sectional view taken along the line VI-VI in FIG. 5

FIG. 7 is a sectional view taken along the line VII-VII FIG. 5.

FIG. 8 is a systematic diagram of a hydraulic circuit and a control system of the crushing device.

FIG. 9 is a part of a flow chart of a crushing control process according to Embodiment 1.

FIG. 10 is a remaining part of a flow chart of the crushing control process according to Embodiment 1.

FIG. 11 is a characteristic diagram showing the correlation between the pressure difference between a pump and a crushing motor, and a hydraulic fluid flow of the crushing motor.

FIG. 12 is a characteristic diagram showing the correlation between the pressure of the crushing motor and a hydraulic fluid flow of a conveyor motor.

FIG. 13 is a characteristic diagram showing the correlation between the pressure of an arm cylinder and a hydraulic fluid flow of the arm cylinder.

FIG. 14 is a characteristic diagram showing the correlation between the pressure of the arm cylinder and the hydraulic fluid flow of the arm cylinder.

FIG. 15 is an external side view of the excavator and the crushing device according to Embodiment 2.

FIG. 16 is a flow chart of the crushing control process according to Embodiment 2.

FIG. 17 is an external side view of the excavator and the crushing device according to Embodiment 3.

### BEST MODE FOR IMPLEMENTING THE INVENTION

Best mode for implementing the present invention will be explained based on embodiments. In the embodiments below, front-rear denotes the front-rear direction seen from the operator of an excavator; up-down denotes the up-down direction in the figures and right-left denotes the right-left direction seen from the operator.

### Embodiment 1

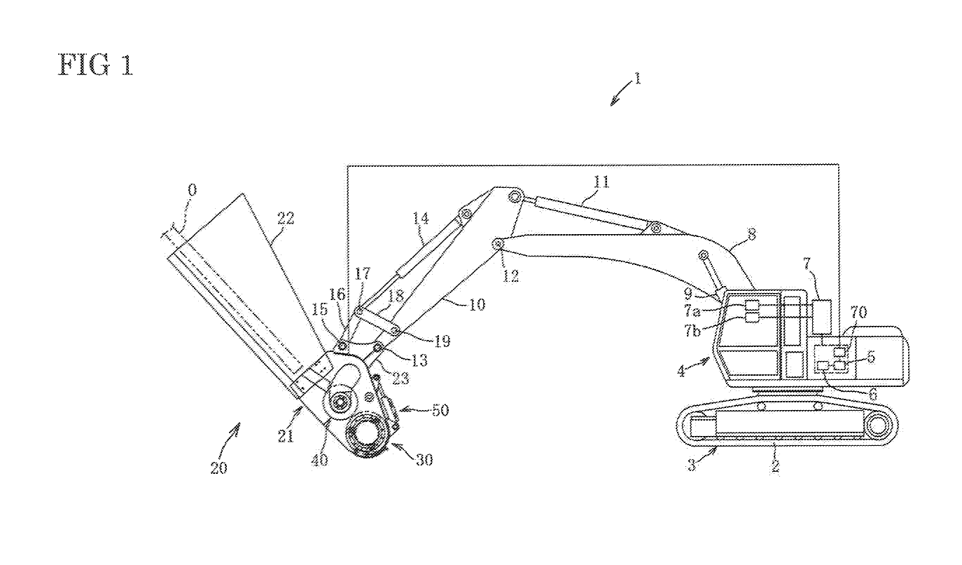

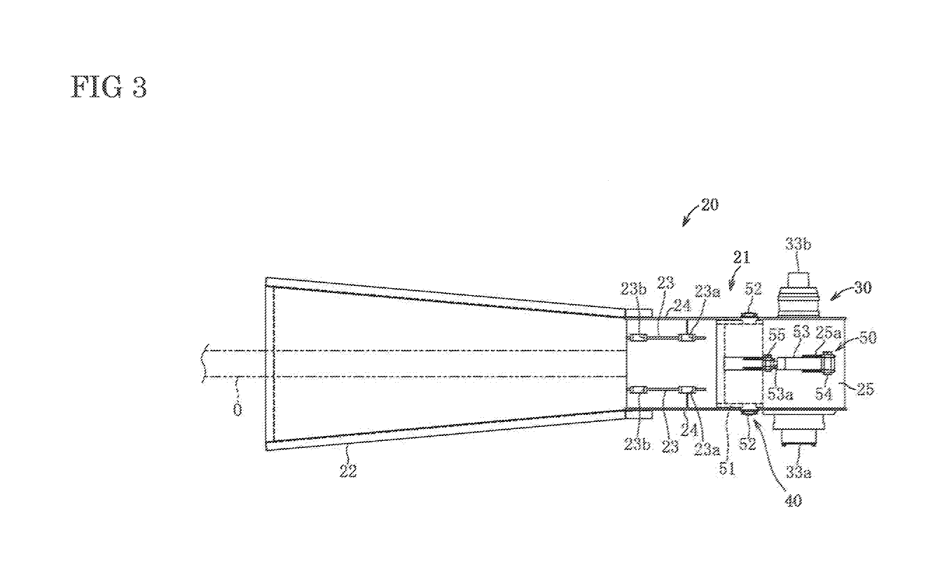

The crushing device according to Embodiment 1 will be described based on FIGS. 1 to 13. As shown in FIG. 1, a hydraulic shovel type excavator 1, which is a digger with a bucket, has a travelling undercarriage 3 equipped with a pair of crawlers 2 and an upper slewing body 4 equipped with an operator cabin which is rotationally mounted on top of the undercarriage 3. A hydraulic pump 5 for supplying hydraulic fluid, a hydraulic power generating engine 6 for driving the hydraulic pump 5, a controller 7 (control means) for controlling the movement of a crushing device 20 described below and a valve unit 70 for supplying hydraulic fluid to the crushing device 20 are disposed at the rear of the upper slewing body 4.

The operator can monitor the movement of the crushing device 20 via an operation monitor 7a provided in the cabin. The cabin has an automatic operation mode switch 7b for switching the hydraulic power generating engine 6 from the idling state to the operating state wherein the engine rotation speed is higher than that of the idling state. Therefore, by selecting the automatic operation mode, the hydraulic power generating engine 6 can be kept in the operating state. Thus, the operator can carry out crushing away from the operator cabin.

The excavator 1 is equipped with a boom 8, the rear end of which is pivotally mounted on the upper slowing body 4, a hydraulic boom cylinder 9 for tilting the boom 8, an excavator arm 10, the rear end of which is pivotally mounted on the front end of the boom 8, a hydraulic arm cylinder 11 for tilting the excavator arm 10 and a crushing device 20, which is coupled to the front end of the excavator arm 10 and can finely crush the object to be crushed O.

The excavator arm 10 is pivotally mounted on the front end of the boom 8 by an arm swing shaft 12. The base end of the cylinder body of the hydraulic arm cylinder 11 is pivotally coupled to the mid-portion of the boom 8 and the end of the piston rod of the arm cylinder 11 is pivotally coupled to the rear end of the excavator arm 10. When the arm cylinder 11 is extended or contracted, the excavator arm 10 swings around the arm swing shaft 12.

The end of excavator arm 10 has a coupling pin 13 which rotationally couples a holder 23 (connector) of the crushing device 20 and a hydraulic bucket cylinder 14 for swinging the crushing device 20 around the coupling pin 13. The base end of the cylinder body of the bucket cylinder 14 is pivotally coupled to the upper portion of the excavator arm 10. The crushing device 20 is a removable attachment of the excavator 1 and is detachably coupled to the front end of the excavator arm 10 by means of coupling pins 13, 15.

As shown in FIGS. 1 to 7, the crushing device 20 has a main body frame 21, which forms the housing of the crushing device 20, a hopper 22 for receiving the loaded object to be crushed O, a crushing mechanism 30, which is positioned on the downstream side of the main body frame 21 with respect to the travel of the material, a conveying mechanism 40, which is positioned on the upstream side of the crushing mechanism 30, a pressing mechanism 50, which pivotally supports the conveying mechanism 40 on a pair of side plates, 24, 24 on the left and right sides of the main body frame 21, and so on. The main body frame 21 has a pair of side plates 24, 24 on the left and right sides, an upper plate 25 with an opening in the center portion, a bottom plate 26, etc. A pair of holders 23 is welded onto the upper plate 25.

Each holder 23 has a coupling pin hole 23a for receiving the coupling pin 13 and a coupling pin hole 23b for receiving the coupling pin 15. The front end of the piston rod of the bucket cylinder 14 is coupled to the rear ends of a pair of H links 16 by means of a coupling pin 17 and the front ends of the H links 16 are coupled to a pair of holders 23 by means of the coupling pin 15 passing through the coupling pin holes 23b. The front ends of a pair of side links 18 are pivotally coupled to the coupling pin 17 and the rear ends of these side links 18 are pivotally coupled to the front portions of the excavator arm 10 by means of a coupling pin 19.

Thus, a four node link mechanism is formed by the coupling pins 13, 15, 17, 19, the H links 16 and the side links 18, wherein the crushing device 20 can be swung up and down around the coupling pin 13 by extending and contracting the bucket cylinder 14 from its initial position shown in FIG. 1.

A removable hopper 22 having a substantially groove shape in cross section is provided on the front end portion of the main body frame 21 on the upstream side before the conveying mechanism 40. The left and right plates of the hopper 22 are respectively fixed onto the main body frame 21 with 6 bolts screwed into 6 bolt holes 24a provided on the front end of the main body frame 21. The hopper 22 has a trapezoidal bottom plate, wherein the width of the bottom plate becomes wider toward the upstream and a pair of trapezoidal side plates connected to the left and right sides of the bottom plate, wherein the width of the side plates becomes wider toward the upstream. Hence the hopper 22 can easily receive lone object to be crushed loaded into the hopper and efficiently introduce the object to be crushed O to the conveying mechanism 40 by reducing the volume of the object to be crushed O as it is conveyed downstream. The hopper 22 can be replaced depending on the type of the object to be crushed. By replacing the hopper 22 depending on the type of the object to be crushed, the hopper 22 of the optimum size and shape can be used.

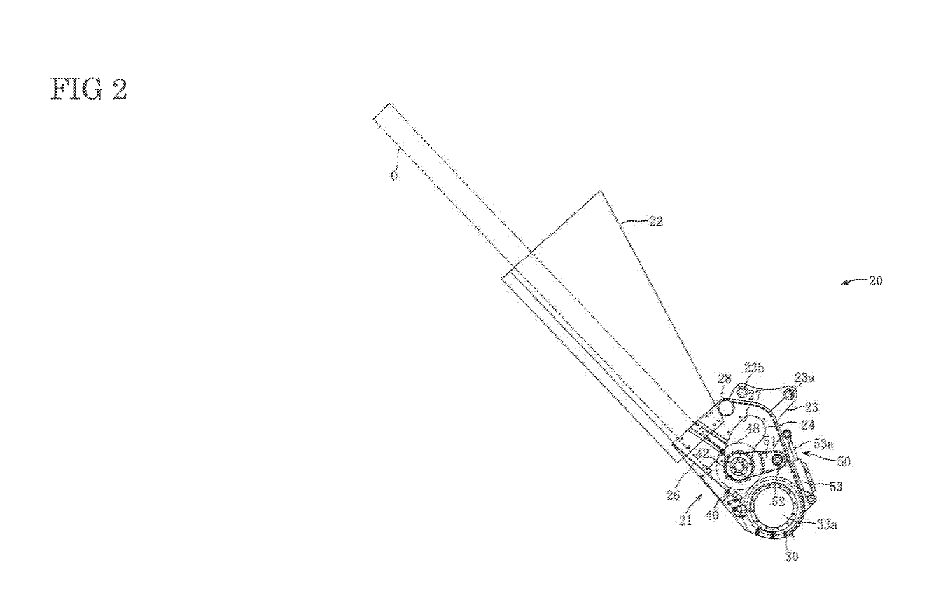

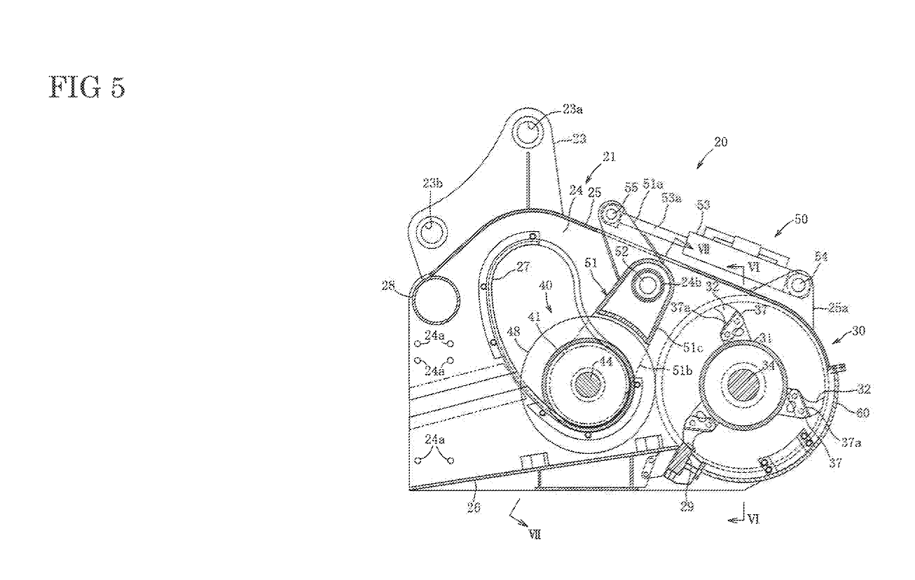

As shown in FIG. 5, the crushing device 20 has a swing opening 27 on the conveying mechanism 40, a loading regulator 28 and a bearing 24b for supporting the swing shaft 52 of the pressing mechanism 50 and so on. As shown in FIG. 1 or 2, the crushing device 20, when processing the object, is kept at a set angle relative to the horizontal line so that the upstream side is held higher than the downstream side. Hence the object to be crushed O is conveyed by sliding down on the bottom plate 26 so that it is not necessary to provide a feed conveyor on the bottom plate 26. Reduction in the size and the weight of the crushing device 20 can be realized. On the bottom plate 26, stationary blades 29 extending substantially perpendicular to the conveying direction is provided on the downstream side in the conveying direction.

The swing opening 27 is an arcuate opening provided respectively on a pair of the side plates 24, 24 to swing the conveying mechanism 40 approximately 45 degrees from the highest position to the lowest position and vice versa. The cylindrical feed regulator 28 is positioned on the upstream side before the conveying mechanism 40 and pivotally mounted on the upper portion of the front end of the main body frame 21, between the pair of the side plates 24, 24. The distance between the feed regulator 28 and the bottom plate 26 is set smaller than the distance between the conveying mechanism 40 moved to the uppermost position and the bottom plate 26.

As shown in FIG. 5, metal meshes 60 covering the vicinity of the lower side of the crushing mechanism 30 is provided on the main body frame 21 on the downstream end in the conveying direction. Crushed fragments smaller than the mesh size is falls through the meshes 60 and fragments larger than the mesh size is further crushed into chips by the stationary blades 29 and the crushing blades 32. A container bag (not shown in the figure) may be mounted underneath the metal meshes 60 to collect processed fragments.

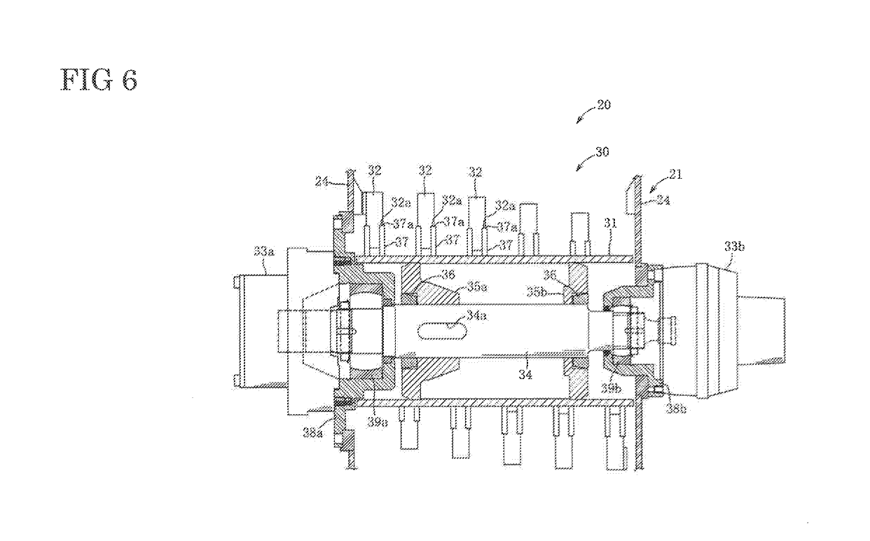

As shown in FIGS. 5 and 6, the crushing mechanism 30 has a crushing rotor 31 rotationally mounted on the left and right side plates 24, 24 of the main body frame 21, a plurality of the crushing blades 32 provided on the periphery of the crushing rotor 31 to crush the conveyed object to be crushed O in cooperation with the stationary blades 29, the first and the second motors 33a, 33b (crushing motor) for rotating the crushing rotor 31 around the rotary shaft 34, etc.

The cylindrical crushing rotor 31 is coupled to the rotary shaft 34 positioned at the shaft center by means of a pair of the coupling members 35a, 35b. On the left side portion of the rotary shaft 34, a depressed key groove 34a extending in the axial direction is provided. A key member (not shown in the figure) integrally provided on the coupling member 35a is fitted into the key groove 34a. This regulates the relative displacement of the rotary shaft 34 and the coupling member 35a in the peripheral direction. Between the rotary shaft 34 and the coupling members 35a, 35b, power locks 36, 36 are provided. The power locks 36, 36 have tapered shapes so that the coupled state of the rotary shaft 34 and the coupling members 35a, 35b is strengthened further with the increase in the rotation speed of the crushing rotor 31.

A plurality of the crushing blades 32 is provided in 3 rows at an interval of 120 degrees around the periphery of the crushing rotor 31. A plurality of crushing blades 32 of each row is positioned spirally on the crushing rotor 31. Each crushing blade 32 is fixed onto the crushing rotor 31 by means of a bracket 37. Each bracket 37 has a flange portion 37a which abuts against the jaw 32a of the crushing blade 32. The flange portions 37a form an angle more than 0 and less than 90 degrees, fir example 45 degrees, to the line extended in the radial direction of the crushing rotor 31. Thus, the stress applied to the crushing blades 32 can be effectively dispersed to the crushing rotor 31 via the bracket 37 during crushing. Moreover, each crushing blade 32 can easily be replaced during maintenance.

The first motor 33a for light load is detachably coupled to the left end of the rotary shaft 34 of the crushing rotor 31 and fixed onto the left side plate 24 of the main body frame 21 by means of the motor flange 38a. The second motor 33b for heavy load is detachably coupled to the right end of the rotary shaft 34 of the crushing rotor 31 and fixed onto the right side plate 24 of the main body frame 21 by means of the motor flange 38b. In between the motor flanges 38a, 38b and the rotary shaft 34, bearings 39a, 39b are provided to rotatably support the rotary shaft 34.

The first and the second motors 33a, 33b are connected detachably via a spline mechanism with each end of the rotary shaft 34. Therefore, in case where the object to be crushed O is small in the supplied volume or is bulky trees not requiring a large crushing force, the second motor 33b is removed and the first motor 33a with a faster rotation speed is used for crushing. But in case where the object to be crushed O is large in the supplied volume or requires a large crushing force, the first motor 33a is removed and the second motor 33b with a larger crushing torque is used for crushing.

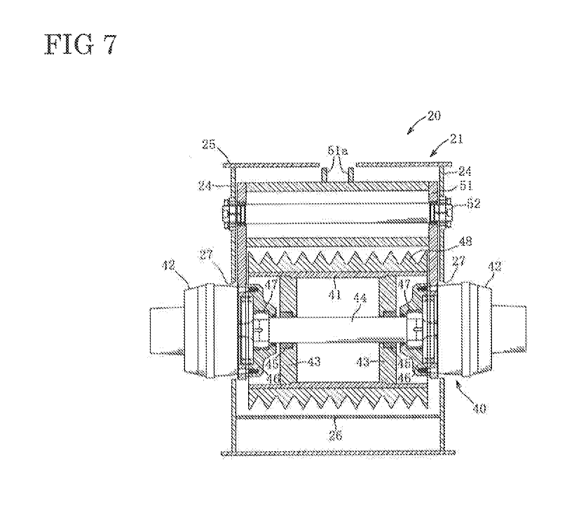

As shown in FIGS. 5 and 7, the conveying mechanism 40 is equipped with a conveying roller 41 provided on the upstream side of the crushing mechanism 30 to press down the object to be crushed O from the upper side toward the bottom plate 26 and to convey the object to be crushed O to the crushing mechanism 30, and a pair of conveying motors 42 on the left and right sides to rotate the conveying roller 41. The cylindrical conveying roller 41 is coupled to the rotary shaft 44 positioned at the shaft center by means of a pair of the coupling members 43, 43. Between the rotary shaft 44 and the pair of the coupling members 43,43, a pair of power locks 45,45 is provided. The power lock 45 has substantially tapered shape so that the coupled state of the rotary shaft 44 and the pair of coupling members 43, 43 is strengthened further with the increase in the rotation speed of the conveying roller 41. The left and right ends of the rotary shaft 44 are rotatably supported by a pair of bearing brackets 46,46 by means of the bearings 47, 47.

On the periphery of the conveying roller 41, annular blade portion 48 with a plurality of annular blades arranged at given intervals in the direction of the shaft center is provided. The annular blade portion 48 is formed so that the blade edge is substantially parallel to the conveying direction at lower most position. Hence the object to be crushed O can be split vertically in case where it is hollow like bamboo. Therefore, when the conveying mechanism 40 presses down the object to be crushed O, the annular blade portion 48 presses and vertically splits or cracks the object to be crushed O. In this way, the pulling force in the conveying direction is efficiently transmitted to the object to be crushed O. A pair of conveying motors 42, 42 is connected via a spline mechanism with both ends of the rotary shaft 44 so as to rotate synchronously. The conveying motor 42 is securely tightened with the bearing bracket 46 and the bolts, holding the front end portion of the arm member 51 in between.

As shown in FIGS. 5 and 7, the pressing mechanism 50 is equipped with the arm member 51 supporting the conveying mechanism 40 on one end (front end), the swing shaft 52 pivotally supporting the other end of the arm member 51 (rear end) on the left and right side plates 24, 24 of the main body frame 21, a hydraulic arm cylinder 53 (arm drive means) which is coupled to the other end (rear end) of the arm member 51 by means of a pair of couplings 51a,51a on the mid-portion of the arm member 51 and which can adjust the pressing force of the conveying roller 41 (annular blades 48) against the object to be crushed O, and so on.

The arm member 51 is equipped with a pair of couplings 51a, a pair of the left and right side plates 51b, 51b substantially parallel to the side plates 24, 24 and a main body portion 51c forming a closed cross section and expanding over from the upper end to the middle of the side plates 51b, 51b as well as extending in the left to right direction and integrally fixed onto the side plates 51b, 51b. Both the left and right ends of the other end (rear end) portions of the arm member 51 are pivotally mounted on a pair of the left and right side plates 24, 24 of the main body frame 21 by means of the swing shafts 52. The arm member 51 is pivotally mounted so as to swing up and down around the swing shaft 52.

Each one end (lower end) of the left and right couplings 51a, 51a is connected to the other end year end) of the main body portion 51c of the arm member 51 substantially in the middle of the left to right direction inclined upward in the forward direction to form an inverted L shape when viewed from the side. The other ends (upper ends) of the left and right couplings 51a, 51a are coupled to the end of the rod 53a of the arm cylinder 53. The left and right couplings 51a, 51a pass through the rectangular aperture provided in the upper plate 25.

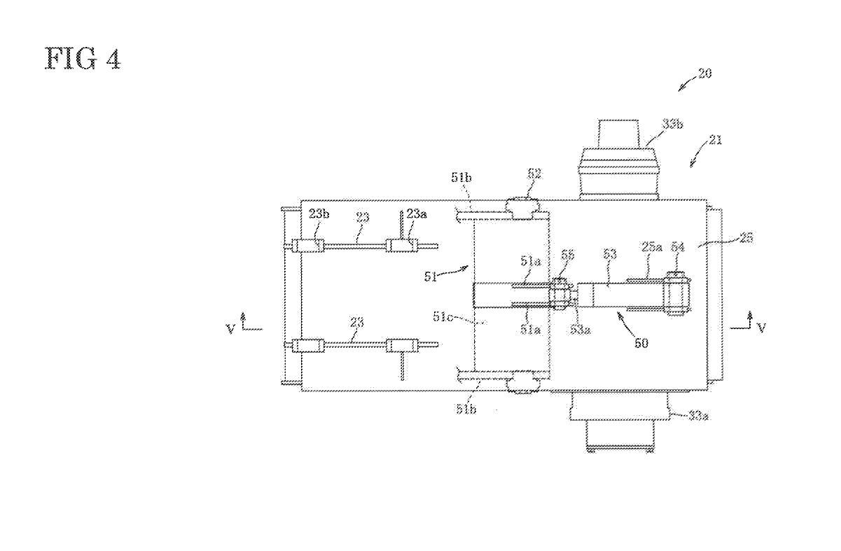

As shown in FIGS. 4 and 5, the base end of the arm cylinder 53 is pivotally coupled to a cylinder support 25a provided on the downstream side of the upper plate 25 and on the upper portion of the crushing mechanism 30 by means of a coupling shaft 54 and the end of the rod 53a of the arm cylinder 53 is pivotally coupled to the other ends of the left and right couplings 51a, 51a by means of a coupling shaft 55. The hydraulic fluid for the arm cylinder 53 is supplied from the hydraulic pump 5 driven by the hydraulic power generating engine 6 and the supplied volume and the discharged volume of the hydraulic fluid is controlled by the controller 7.

Thus, when the rod 53a of the arm cylinder 53 is most extended, the arm member 51 turns counterclockwise around the swing shaft 52 so that the distance between the conveying mechanism 40 and the bottom plate 26 comes to the minimum (lowermost position). When the rod 53a of the arm cylinder 53 is most contracted, the arm member 51 turns clockwise around the swing shaft 52 so that the distance between the conveying mechanism 40 and the bottom plate 26 comes to the maximum (uppermost position).

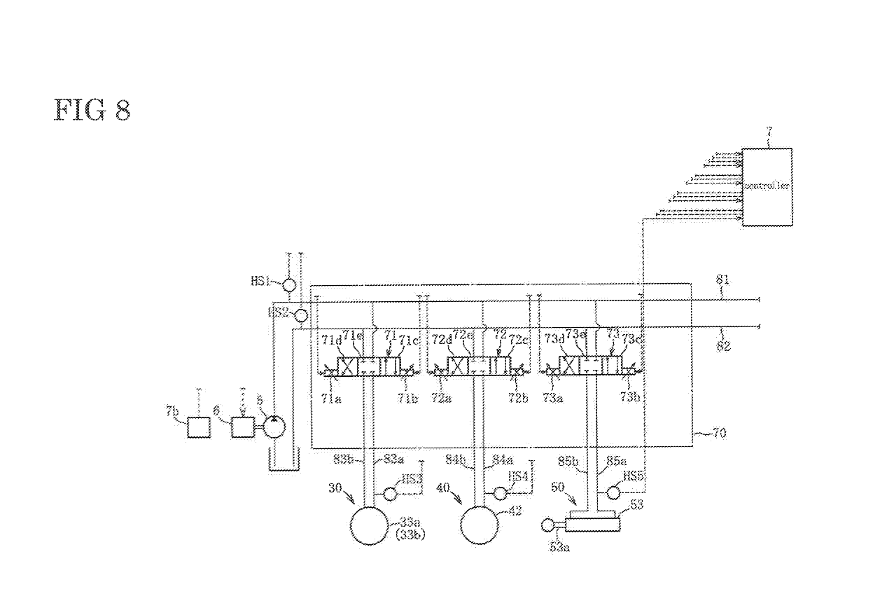

Based on FIG. 8, the valve unit 70 of the crushing device 20 will be described.

As shown in FIG. 8, the pressurized hydraulic fluid discharged from the hydraulic pump 5 passes through the oil passage 81 and is supplied to the mechanisms 30, 40 and 50 via the valve unit 70. The used hydraulic fluid passes through the oil passage 82 via the valve unit 70 and returns to the oil tank. The valve unit 70 has the first, the second and the third control valves 71 to 73. The first, the second and the third control valves 71 to 73 control the direction and the flow of the hydraulic fluid to be supplied by means of respective variable solenoid 71a to 73a, 71b to 73b electrically connected to the controller 7.

When the first motor 33a is rotated in the normal direction, the first control valve 71 is switched to position 71c. When the first motor 33a is rotated in the reverse direction, the first control valve 71 is switched to position 71d. When the first motor 33a is stopped, the first control valve 71 is switched to neutral position 71e. Even when a second motor 33b is mounted, similar switching control is carried out. When the conveying motor 42 is rotated in the normal direction, the second control valve 72 is switched to position 72c and when the conveying motor 42 is rotated in the reverse direction, the second control valve 72 is switched to position 72d. When the conveying motor 42 is stopped, the second control valve 72 is switched to neutral position 72e.

When the rod 53a of the arm cylinder 53 is extended, the third control valve 73 is switched to position 73e and when the rod 53a is shortened (contracted), the third control valve 73 is switched to position 73d. When the rod 53a is not extended nor contracted, the third control valve 73 is switched to neutral position 73e. When setting the rod 53a to move neutrally (in neutral mode free to extend and contract), the third control valve 73 is switched to position 73e and the relief valve (not shown in figure) which connects the cylinder passages 85a, 85b and the oil passage 82 is opened to drain the hydraulic fluid from the cylinder passages 85a, 85b.

The oil passages 81, 82 are respectively provided with hydraulic sensors HS1 and HS2. The motor oil passages 83a, 84a are respectively provided with hydraulic sensors HS3 (second drive load detector) and HS4 (first drive load detector) and the cylinder oil passage 85a is provided with a hydraulic sensor HS5. The hydraulic pressure values (P1 to P5) detected by the hydraulic sensors HS1 to HS5 are transmitted to the controller 7. The controller 7 carries out various calculations based on the values detected by the hydraulic sensors HS1 to HS5 and transmits control signals to the variable solenoid 71a to 73a, 71b to 73b. In the present embodiment, the use of variable solenoid 71a to 73a, 71b to 73b enables linear switching of the pressurized oil flow to each mechanism 30, 40, 50 during transition to each operating position.

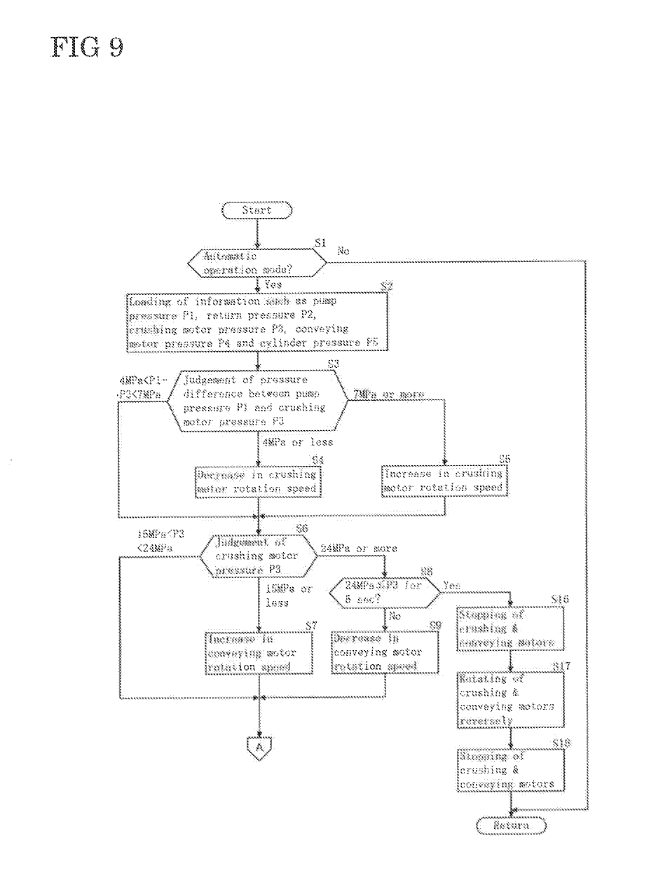

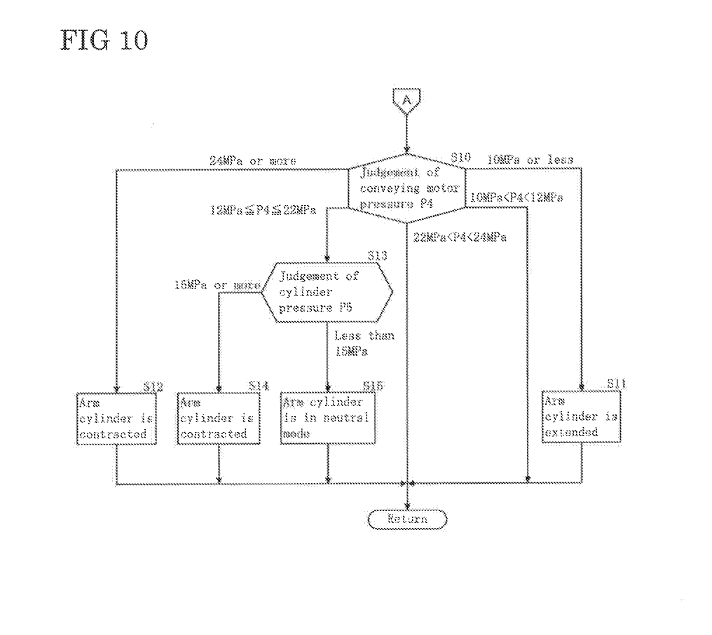

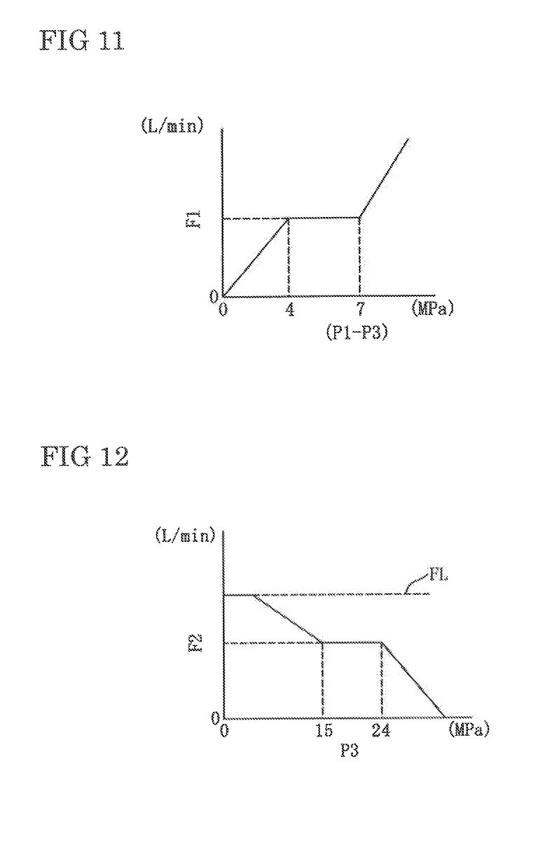

Next, based on the flow charts in FIGS. 9 and 10, crushing control process of the controller 7 will be described. Now, Si (i=1, 2 . . . ) denotes each step. In this embodiment, the first motor 33a is used as the crushing motor. This crush control program and the maps shown in the related FIG. 11 to FIG. 14 are installed beforehand in the controller 7. In S1, whether the automatic operation mode switch 7b is switched on or not, that is, whether the automatic operation mode is selected or not, is judged to check whether crushing is being carried out or not. In case where the automatic operation mode is selected, the process moves on to the next step S2. In the automatic operation mode, the hydraulic pump 5 is driven at a constant rotation speed, and the first motor 33a (or the second motor 33b) for crushing and the conveying motor 42 are usually driven in the normal direction.

In S2, various values such as the pump pressure P1 detected by the hydraulic sensor HS1, the return pressure P2 detected by the hydraulic sensor HS2, the crushing motor pressure P3 detected by the hydraulic sensor HS3, the conveying motor pressure P4 detected by the hydraulic sensor HS4, the cylinder pressure P5 detected by the hydraulic sensor HS5, etc. are loaded and the process moves on to the next step S3. When it is judged that the automatic operation mode is not selected in S1, the process returns to the start.

In S3, the pressure difference (P1−P3) between the pump pressure P1 and the crushing motor pressure P3 is judged. When the pressure difference (P1−P3) is not larger than the set value (for example 4 MPa), in case where the rotation speed of the hydraulic pump 5 has not sufficiently increased, for example, immediately after the start of processing so that there is no allowance in the pump pressure P1 or in case where the crushing load is excessive, the first control valve 71 is controlled to decrease the rotation speed of the first motor 33a (normal rotation) based on the map shown in FIG. 11 (S4). Then the process moves on to S6.

FIG. 11 shows a map in which the pressurized oil flow F1 to the first motor 33a is determined using the pressure difference (P1−P3) as the parameter. In this map, the pressure difference (P1−P3) increases when the crushing motor 33a is under light load. Thus, the oil flow F1 is increased to raise the rotation speed. When it is under appropriate load, the oil flow F1 is maintained. When it is under excessive load, the pressure difference (P1−P3) decreases. Hence the oil flow F1 is decreased to lower the rotation speed.

In case where the pressure difference (P1−P3) is 4 MPa or less, the oil flow F1 is decreased so as to decrease the crushing motor rotation speed (S4). In case where the pressure difference (P1−P3) is not smaller than the eset value (for example 7 MPa), there is allowance in the pump pressure P1 and the processing capacity of the crushing motor 33a. Hence the oil flow F1 is increased to the level corresponding to the pressure difference (P1−P3) so as to raise the rotation speed of the first motor 33a (S5) and then the process moves on to S6.

In case where the pressure difference (P1−P3) is within the preset range (for example, larger than 4 MPa and smaller than 7 MPa), the rotation speed is appropriate for the load of the crushing motor. Hence the oil flow F1 is maintained and the process moves on to S6.

In S6, the drive load of the first motor 33a is detected by means of the crushing motor pressure P3. In steps after S6, the conveying speed of the object to be crushed O (i.e. the supplying state of the object to be crushed O) is determined using the crushing motor pressure P3 as the parameter. In case where it is judged in S6 that the crushing motor pressure P3 is not larger than the set value (for example 15 MPa), the first motor 33a has allowance in the processing capacity. Therefore, based on the map in FIG. 12, the rotation speed of the conveying motor 42 is increased in S7 and the process moves on to S10.

FIG. 12 shows a map in which the pressurized oil flow F2 to the conveying motor 42 is determined using the crushing motor pressure P3 as the parameter. When the crushing motor pressure P3 is low and there is allowance in the crushing capacity, the rotation speed of the conveying motor 42 is increased, and when the crushing motor pressure P3 is within the appropriate range, the rotation speed of the conveying motor 42 is maintained. When the crushing motor pressure P3 is high due to the excessive load, the rotation speed of the conveying motor 42 is decreased.

In case where it is determined in S6 that the crushing motor pressure P3 is equal to or larger than the set value (second set load) (for example 24 MPa), the supplying volume of the object to be crushed O is excessive so that the first motor 33a is under excessive load. The process moves on to S8 to judge whether the crushing motor pressure P3 of 24 MPa or more is kept for 5 sec or more. This is to judge whether the crushing blades 32 is clogged with the object to be crushed O or not.

In case where it is judged to be No in S8, although the crushing blades 32 is not clogged, the supplying volume of the object to be crushed O is excessive. Hence the rotation speed of the conveying motor 42 is lowered. In such a case, the second control valve 72 is controlled to make the oil flow F2 correspond to the crushing motor pressure P3 based on the map in FIG. 12 (S9). Then, the process moves on to S10.

In case where it is judged in S6 that the crushing motor pressure P3 is within the preset range (for example, larger than 15 MPa and smaller than 24 MPa), the first motor 33a is rotating at a speed suitable for the load. Hence the oil flow F2 of the conveying motor 42 is maintained and the process moves on to S10.

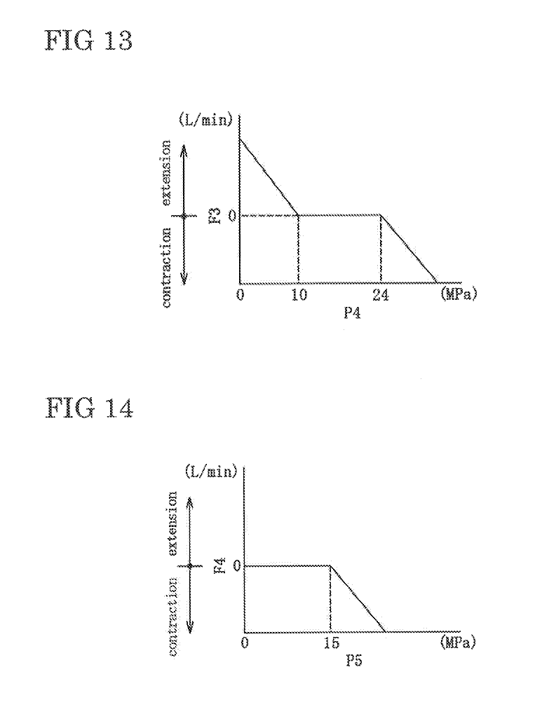

S10 to S15 are steps for controlling the extending length of the rod 53a based on the conveying motor pressure P4 and the cylinder pressure P5. In S10, the conveying load of the conveying motor 42 is detected by means of the conveying motor pressure P4. Here, this conveying motor pressure P4 is judged. When it is judged in S10 that the conveying motor pressure P4 is not larger than the set value (for example 10 MPa), there is allowance in the conveying capacity. Hence the third control valve 73 is controlled based on the map in FIG. 13 to increase the extending length of the rod 53a of the arm cylinder 53 so that the arm member 51 is swung down from the present position (S11). Then, the process returns to the start.

In FIG. 13, the pressurized oil flow F3 is determined using the conveying motor pressure P4 as the parameter when the rod 53a of the arm cylinder 53 is extended or contracted. In the map of FIG. 13, the rod 53a is extended when the conveying motor pressure P4 is small, kept as it is when the conveying motor pressure P4 is within the appropriate range and contracted when the conveying motor pressure P4 is large.

In case where it is judged in S10 that the conveying motor pressure P4 is not smaller than the set value (first set load) (for example 24 MPa), the conveying load has become excessive due to excessive loading of the object to be crushed O. Hence the rod 53a is contracted and the third control valve 73 is controlled based on the map in FIG. 13 to swing the arm member 51 upward (S12). Then the process returns to the start.

The crushing device 20 is held at a given inclination angle relative to the horizontal line during crushing. Therefore, in order to prevent a mass of the object to be crushed O sliding down on the bottom plate 26 from clashing against the crushing mechanism 30, the position, wherein the rod 53a of the arm cylinder 53 is most extended, that is, the lowermost position, wherein the distance between the conveying roller 41 and the bottom plate 26 is at the minimum, is set as the initial position. Hence the distance between the conveying roller 41 and the bottom plate 26 is controlled to increase immediately after the start of crushing.

In case where it is judged in S10 that the conveyor motor pressure P4 is within the set range (for example, larger than 10 MPa and smaller than 12 MPa, or larger than 22 MPa and smaller than 24 MPa), the rod 53a of the arm cylinder 53 is kept as it is and the process returns to the start.

In case where it is judged in S10 that the conveyor motor pressure P4 is within the preset range, (for example, 12 MPa or more and 22 MPa or less), the process moves on to S13 and the working load of the cylinder 53 is detected by means of the cylinder pressure P5. Here, the cylinder pressure P5 is judged. FIG. 14 shows the pressurized oil flow F4 when the rod 53a of the arm cylinder 53 is extended or contracted using the cylinder pressure P5 as the parameter. This map shows that the rod 53a is kept as it is when the cylinder pressure P5 is within the predetermined range and contracted when the cylinder pressure P5 is larger than the given range.

In case where it is judged in S13 that the cylinder pressure P5 is not smaller than the set value (for example 15 MPa), the working load of the arm cylinder 53 has become excessive. Thus the third control valve 73 is controlled to contract the rod 53a and the arm member 51 is swung upward (S14). Then the process returns to the start.

In case where it is judged in S13 that the cylinder pressure P5 is smaller than the set value (for example smaller than 15 MPa), the outside diameter of the object to be crushed O has become small. When the reaction force from the object to be crushed O toward the conveying roller 41 is small, the third control valve 73 is switched to the neutral position 73e to swing the arm member 51 downward by its own weight. At the same time the oil passages 85a, 85b are connected to the oil passage 82 and the arm cylinder 53 is switched to the neutral mode (S15). Then the process returns to the start.

In case where it is judged in S8 that the crushing motor pressure P3 is kept at 24 MPa or more for 5 seconds or more, the crushing blades 32 is clogged with the object to be crushed O. In such a case, the normal rotation of the first motor 33a and the conveyor motor 42 is stopped for a given period (for example, 1 sec) (S16). Next, the first motor 33a and the conveying motor 42 are rotated in the reverse direction for a given period (for example, 2 sec) (S17) and again, the first motor 33a and the conveying motor 42 are stopped for a given period (for example, 1 sec) (S18). Then, the process returns to the start. In case where the second motor 33b is mounted as the crushing motor in place of the first motor 33a, similar control as above will be carried out.

Next, functions and advantages of the crushing device 20 will be described.

In the crushing device 20, because the pressing mechanism 50 is equipped with the arm member 51 holding the conveying mechanism 40 on one end, the swing shaft 52 pivotally supporting the arm member 51 on the main body frame 21 and the arm cylinder 53, which is coupled to the other end of the arm member 51, for adjusting the pressing force of the conveying roller 41 toward the object to be crushed O, the conveying roller 41 can be pressed laterally against the face substantially parallel to the conveying direction of the object to be crushed O regardless of the property, such as the outer shape, of the object to be crushed O. The controller 7 controls the driving force of the arm cylinder 53 (pressing force of the conveying roller) depending on the conveying motor pressure P4 which corresponds to the drive load of the conveying motor 42. Hence appropriate relative position of the conveying roller 41 and the object to be crushed O can be determined depending on the conveying state and the property, such as hardness, of the object to be crushed O.

Therefore, regardless of the outer shape of the object to be crushed O, the face substantially parallel to the conveying direction of the object to be crushed O can be pressed laterally without the conveying roller 41 hindering the forwarding movement of the object to be crushed O and the object to be crushed can be conveyed without fail to the crushing mechanism 30 and crushed. Moreover, pressing force suitable for the property of the object to be crushed O can be applied to the object to be crushed O so that sufficient pulling force is applied to the object to be crushed O, thus preventing the decline in the conveying speed and the crushing efficiency.

Since the controller 7, when the conveying motor pressure P4 of the conveying motor 42 is larger than the set pressure corresponding to the first set load, reduces the pressing force of the conveying roller 41 so that the object to be crushed O is prevented from abutting against the upstream side of the annular blades 48 provided on the conveying roller 41 even when the object to be crushed O has a large outer shape. Hence conveyance is not hindered and the material is conveyed to the crushing mechanism 30 by means of the annular blades 48 and crushed.

The controller 7, equipped with the hydraulic sensor HS3 for detecting the crushing motor pressure P3 corresponding to the drive load of the first and the second motors 33a, 33b, controls the conveying motor 42 to decrease the conveying speed of the object to be crushed O when the drive load of the first and the second motors 33a, 33b is larger than the set pressure corresponding to the second set load. Therefore, without installation of a separate detection sensor, etc., the excessive supply of the object to be crushed O can be detected using the crushing motor pressure P3 of the first and the second motors 33a, 33b as the parameter. Thus, appropriate volume of the object to be crushed O can be supplied, to the crushing mechanism 30.

The main body frame 21 is equipped with a holder 23 for pivotally coupling the crushing device 20 to the end of the excavator arm 10 of the excavator 1. In advance, the crushing device 20 can be moved to an arbitrary desired position by means of the boom 8 and the arm 10 of the hydraulic excavator 1 and the posture of the crushing device 20 can be set freely by means of the bucket cylinder 14. Hence working efficiency such as loading of the object to be crushed O, output of the crushed object, etc. can be raised. Moreover, crushing can be carried out in poor working environments such as sloped grounds. Since the crushing device 20 itself does not require travelling means nor feed conveyor for the object to be crushed, the size, the weight and the production cost of the crushing device can be reduced.

Because the hopper 22 for receiving the loaded object to be crushed O is detachably mounted on the upstream side of the conveying mechanism 40 of the main body frame 21, long object to be crushed O can be loaded with ease into the crushing device 20 and supplied without fail to the crushing mechanism 30 by means of the conveying mechanism 40. Moreover, a hopper 22 most suitable for the object to be crushed O can be used if plural types of the hopper 22 are kept at hand.

Because the crushing motor has the first motor 33a for light load detachably mounted on one end of the rotary shaft 34 of the crushing rotor 31 and the second motor 33b for heavy load detachably mounted on the other end of the rotary shaft 34 of the crushing rotor 31, either the first motor 33a for light load or the second motor 33b for heavy load for driving the crushing rotor 31 can be selected depending on the supplied volume and the property, such as hardness, of the object to be crushed O, thus increasing the crushing efficiency.

### Embodiment 2

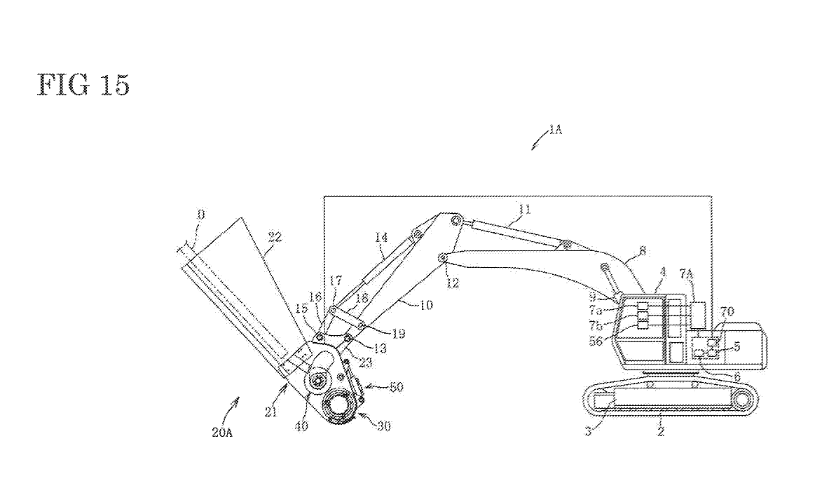

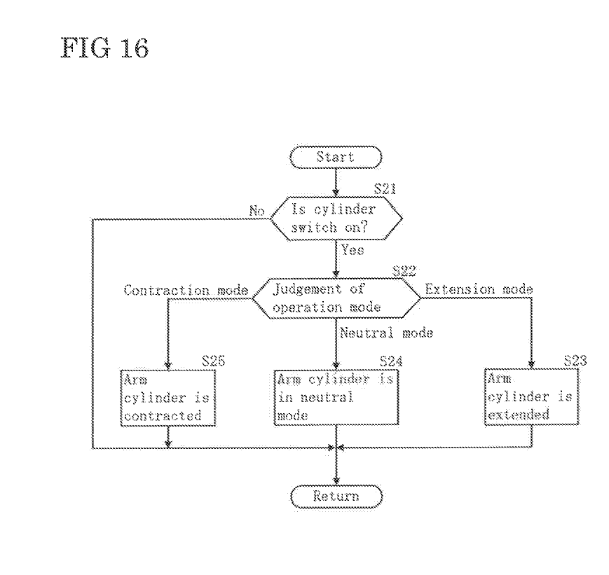

Next, the crushing device 20A related to the Embodiment 2 will be described based on FIGS. 15 and 16. The same reference numerals are assigned to the same components as in Embodiment 1. Explanation will be given only to the different components.

As shown in FIG. 15, a cylinder switch 56 for selecting the operating mode of the arm cylinder 53 among a plurality of the operating modes (extension mode, neutral mode, contraction mode) is provided in the operating cabin of the excavator 1A. The selected signal from the cylinder switch 56 is transmitted to the controller 7A. Thus the operator can extend/contract the arm cylinder 53 in a given mode by switching the cylinder switch 56.

Based on the flow chart in FIG. 16, the crushing control process of the controller 7A will be described. Si (i=21, 22 . . . ) denotes each step. This crushing control process is executed independently from the crushing control process in Embodiment 1.

In S21, whether the cylinder switch 56 is switched on or not is judged. In case where it is determined in S21 that the cylinder switch 56 has been switched on, the process moves on to S22 to determine which operating mode has been selected. In case where it is determined in S21 that the cylinder switch 56 is not switched on, the process returns to the start. In case where it is determined in S22 that the extension mode has been selected, the controller 7A extends the rod 53a by a given length (S23) so as to swing the arm member 51 downward and the process returns to the start.

In case where it determined in S22 that the neutral mode has been selected, the arm cylinder 53 is moved to the neutral mode (S22) so as to swing the arm member 51 downward by its own weight and the process returns to the start. Since the controller 7A does not control the hydraulic pressure of the arm cylinder 53, the rod 53a is kept free to extend and contract.

In case where it is determined in S22 that the contraction mode is selected, the controller 7A contracts the rod 53a by a specific length (S23) so as to swing the arm member 51 upward and the process returns to the start. Thus, the operator can arbitrarily extend or contract the arm cylinder 53 depending on the operating condition or by monitoring the operating monitor 7a.

### Embodiment 3

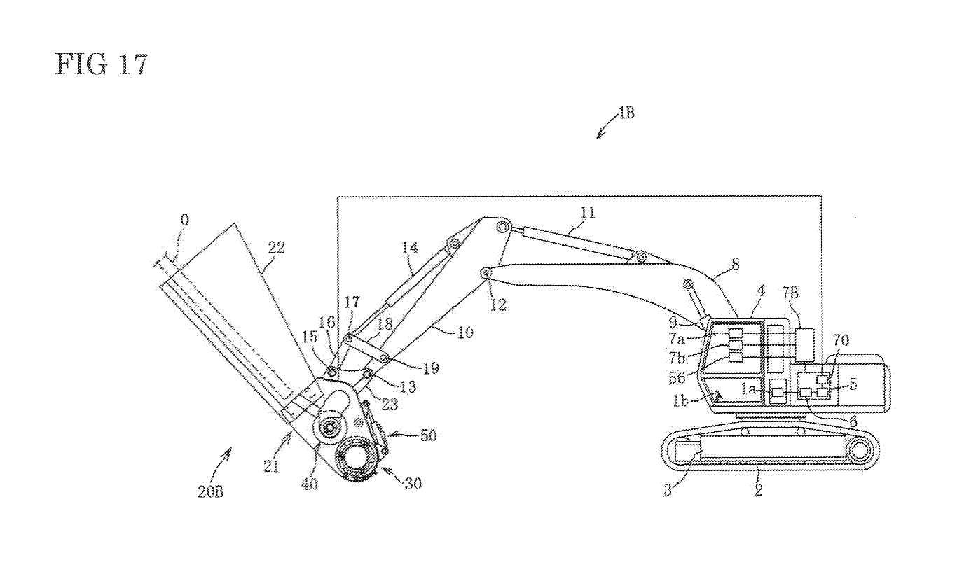

Next, the crushing device 20B related to Embodiment 3 will be described based on FIG. 17. Since the same reference numerals are assigned to the same components as in Embodiment 1, the explanation thereof will be omitted. Explanation will be given only to the different components. The excavator 1B is equipped with a controller 1a, a hydraulic pedal 1b (switch), a hydraulic auto-deceleration sensor (not shown in the figure), a controller 7B for the crushing device 20B and so on.

The controller 1a of the excavator can adjust the rotation speed of the hydraulic power generating engine 6 based on the actuation signal of the hydraulic pedal 1b, etc. given by the operator. The controller has an auto-deceleration system which reduces the rotation speed of the hydraulic power generating engine 6 to the idling speed when the hydraulic pedal 1b is not operated for a given period of time. The amount of hydraulic fluid supplied from the hydraulic pump 5 to the operating members such as the boom cylinder 9, the arm cylinder 11, the bucket cylinder 14, etc. can be adjusted depending on the travel of the hydraulic pedal 1b.

The hydraulic auto-deceleration sensor is positioned between the hydraulic pump 5 and the operating members, detects the hydraulic fluid supplied to the operating members and outputs the results to the controller 1a of the excavator. The controller is of the excavator detects the travel of the hydraulic pedal 1b by the output signal of the hydraulic auto-deceleration sensor to determine whether it is necessary to start auto-deceleration or not.

The controller 7B, when both the crushing motor pressure P3 and the conveying motor pressure P4 are kept below the preset value (for example 5 MPa) corresponding the third set load for a given period (for example 5 sec) or longer, prohibits the detection signal of the hydraulic auto-deceleration sensor from being transmitted to the controller 1a of the excavator. Hence when the object to be crushed O is not loaded into the crushing device 20B for a given period of time, the auto-deceleration system enables the hydraulic power generating engine 6 to enter the idling state, wherein the rotation speed is lower than that of the operating state. The crushing motor pressure P3 and the conveying motor pressure P4 can be set at different values.

Similarly, the controller 7B, even when the automatic operation mode is selected by the automatic operation mode switch 7b, prohibits the detection signal of the hydraulic auto-deceleration sensor from being transmitted to the controller 1a of the excavator in case where both the crushing motor pressure P3 and the conveying motor pressure P4 are kept below the preset value for a given period. Thus, when the drive load of the motors is small, the hydraulic power generating engine 6 can be switched automatically from the operating state to the idling state. Energy consumption can be held down in this way. Now, when the object to be crushed O is loaded into the crushing device 20B, the crushing motor pressure P3 and the conveying motor pressure P4 are generated. Thus, the hydraulic power generating engine 6 returns from the idling state to the operating state.

Next, variations wherein above described embodiment is partially modified, will be described.

1) In above embodiment, a case wherein the hopper 22 is detachably mounted on the main body frame 21, was described. But it is also acceptable to integrate the hopper 22 into the main body frame 21.

2) in above embodiment, a case wherein the object to be crushed is caught between the conveying roller and the bottom plate, was described. However, it is also possible to provide a plurality of driven rollers rotatably supported on the upstream side of the stationary blades. In such a case, the crushing device can be operated at a substantially horizontal state. It is also possible to provide a plurality of partially cylindrical convexes on the surface of the bottom plate and to provide a bottom plate to form a corrugated wall.

3) In above embodiment, a case where the first and second motors are detachably mounted on the crushing mechanism, is described. In this case, either the first or the second motor is selected depending on the object to be crushed and the unnecessary motor is dismounted. However, it is also possible to provide a clutch mechanism respectively between the first, the second motors and the rotary shaft so that the motors can be connected to or disconnected from the rotary shaft by means of the clutch mechanism.

4) Besides above described variations, persons killed in the art are able to make various modifications to above embodiments without deviating from the present invention. Such variations shall be included, in the present invention.

### INDUSTRIAL APPLICABILITY

The present invention relates to the crushing device for crushing conveyed arborous material such as bamboo, thinned wood and waste wood into chips, by controlling the driving force of the arm drive means depending on the drive load of the conveying motor, the object to be crushed can be conveyed without fail to the crushing mechanism regardless of the outside appearance of the object to be crushed and appropriate pressing force can be applied to the object to be crushed depending on the property of the object to be crushed.

### DESCRIPTION OF NUMERALS

1, 1A, 1B excavator
1a controller of excavator
1b hydraulic pedal
6 hydraulic power generating engine
7, 7A, 7B controller
7b automatic operation mode switch
10 excavator arm
14 bucket cylinder
20, 20A, 20B crushing device
21 main body frame
22 hopper
23 holder
29 stationary blades
30 crushing mechanism
31 crushing rotor
32 crushing blades
33a primary motor
33b secondary motor
34 rotary shaft
40 conveying mechanism
41 conveying roller
42 conveying motor
50 pressing mechanism
51 arm member
52 swing shaft
53 arm cylinder
S3, S4 hydraulic sensor
O object to be crushed

1. A crushing device comprising a main body frame pivotally coupled to an end of an arm of a shovel type excavator, stationary blades fitted on the main body frame and crushing blades for crushing conveyed object to be crushed in cooperation with the stationary blades, wherein the crushing device comprises:
a crushing mechanism comprising a crushing rotor rotationally mounted on the main body frame, a plurality of the crushing blades fitted on a periphery of the crushing rotor and a crushing motor for rotating the crushing rotor around a rotary shaft;
a conveying mechanism comprising a conveying roller provided on an upstream side of the crushing mechanism for pressing and conveying the object to be crushed to the crushing mechanism and a conveying motor for rotating the conveying roller;
a pressing mechanism comprising an arm member holding the conveying mechanism on one end, a swing shaft pivotally supporting the arm member on the main body frame and an arm drive means coupled to the other end of the arm member for adjusting a pressing force of the conveying roller against the object to be crushed; and
a hopper capable of receiving the loaded object to be crushed and provided on the main body frame detachably or integrally on an upstream side than the conveying mechanism.

2. The crushing device according to claim 1, wherein provided are a first drive load detection means for detecting a drive load of the conveying motor and a control means for controlling a drive load of the arm drive means depending on the drive load of the conveying motor.

3. The crushing device according to claim 2, wherein the control means reduces the pressing force of the conveying roller when the drive load of the conveying motor is larger than a first set load.

4. The crushing device according to claim 2, wherein provided is a second drive load detection means for detecting a drive load of the crushing motor and the control means controls the conveying motor to reduce a conveying speed of the object to be crushed when the drive load of the crushing motor is larger than a second set load.

5. The crushing device according to claim 1, wherein the crushing motor and the conveying motor are both hydraulic motors and wherein provided are
a hydraulic pump to supply hydraulic fluid at least to the crushing motor and the conveying motor,
a hydraulic power generating engine for driving the hydraulic pump, and
a switch for switching the hydraulic power generating engine from an idling state to an operating state wherein an engine rotation speed is higher than that of the idling state;
and wherein even when the switch is set to the operating state, the hydraulic power generating engine is switched from the operating state to the idling state in case where the drive load of the crushing motor and the conveying motor is smaller than a third set load.

6. The crushing device according to claim 5, wherein the crushing motor has a first motor for light load detachably mounted on one end of the rotary shaft of the crushing rotor and a second motor for heavy load detachably mounted on the other end of the rotary shaft of the crushing rotor.
